(19) United States
(12) Patent Application Publication
(10) Pub. No.: US 2013/0238205 A1
(43) Pub. Date: Sep. 12, 2013

(54) SYSTEM AND METHOD FOR PROVIDING AUXILIARY BRAKING TO A TOWED VEHICLE

(71) Applicants: Jerry A. Edwards, Portland, OR (US); Michael Cannon, Vancuver, WA (US)

(72) Inventors: Jerry A. Edwards, Portland, OR (US); Michael Cannon, Vancuver, WA (US)

(21) Appl. No.: 13/789,333

(22) Filed: Mar. 7, 2013

Related U.S. Application Data
(60) Provisional application No. 61/608,250, filed on Mar. 8, 2012.

(51) Int. Cl. B60T 7/12

(52) U.S. Cl. CPC B60T 7/12
USPC 701/70; 74/108; 254/93 VA

(57) ABSTRACT

An auxiliary braking device for use in a towed vehicle has an actuator with a moving element that connects via a cable or the like to a brake pedal arm of the towed vehicle. A pulley or similar redirection device is located in the space behind the brake pedal arm with the cable being routed from the actuator to the brake pedal arm via the pulley ensuring that the line of pull on the brake pedal arm is in the direction of the brake pedal's normal movement. The actuator may be a pneumatic actuator that is controlled by pressurized air from an air compressor of a controller.

### CROSS REFERENCE TO RELATED APPLICATIONS

This application claims priority to U.S. provisional patent application Ser. No. 61/608,250, filed 8 Mar. 2012, the contents of which are herein incorporated by reference.

### FIELD OF THE INVENTION

The present invention relates to auxiliary braking devices that are used to provide auxiliary braking to a towed vehicle.

### BACKGROUND

People who often tow vehicles, such as those who tow automobiles with their recreational vehicles, can encounter towing problems. One common towing problem pertains to the braking system of the towing vehicle. When a vehicle is being towed, the towed vehicle may rely on the braking system of the towing vehicle for stopping or slowing down. This situation typically produces undue stress on the towing vehicle's braking system. The undue stress may cause the brake pads of the towing vehicle to wear out faster than normal. Thus, the life span of the towing vehicle's braking system could be significantly shortened. This situation may render the towing vehicle prone to accidents including the loss of braking

An additional problem is that the overall stopping distance is increased. To combat the increased weight of the towing vehicle/towed vehicle assembly, the driver normally just steps harder on the brakes. However, in a panic stop the assembly will only stop so fast.

Auxiliary braking devices have been deployed in towed vehicles that enable the brakes of the towed vehicle to be utilized. Having auxiliary brakes eliminates the towed car's momentum from pushing the towing vehicle, thereby allowing the towing vehicle to stop in the same distance it would if not towing. Thus, auxiliary brakes helps prevent accidents that can't be avoided without the extra brake assistance.

Another common towing problem pertains to the risk of the towed vehicle detaching from the towing vehicle. When a vehicle is being towed, frequent stops or deceleration may create significant stress on the vehicle connection system, such as the tow hitch. If stress exceeds the structural strength of the tow hitch, catastrophic failure of the tow hitch may result. In such an event, the towed vehicle may detach from the towing vehicle.

What is required, is an improved system and method for providing auxiliary braking to a towed vehicle.

### SUMMARY OF ONE OR MORE EMBODIMENTS OF THE INVENTION

### Advantages of One or More Embodiments of the Present Invention

The various embodiments of the present invention may, but do not necessarily, achieve one or more of the following advantages:

the ability to provide auxiliary braking to a towed vehicle;

the ability to provide emergency breakaway braking to a towed vehicle;

an auxiliary braking system that can pull on the brake pedal arm of the towed vehicle;

provide an installation that does not need to be removed when the towed vehicle is required to be driven;

the ability to utilize a power assist booster of the towed vehicle;

the ability to see via a monitor the braking status of the towed vehicle within the towing vehicle;

the ability to hear an emergency alarm for a breakaway event or braking when the system should not be braking; and

the ability to trickle charge the towed car's battery while towing.

These and other advantages may be realized by reference to the remaining portions of the specification, claims, and abstract.

### Brief Description of One Embodiment of the Present Invention

In one embodiment, there is provided an auxiliary braking device for use in a towed vehicle, the towed vehicle including brakes, a driver cockpit, a brake pedal arm in the driver cockpit for applying the brakes, the brake pedal arm having a non-braking position in which the brakes of the towed vehicle are not applied and a braking position in which the brakes of the towing vehicle are applied. A first attachment attaches at a brake pedal arm of the towed vehicle and a second attachment attaches to the towed vehicle at a position behind the brake pedal arm as viewed from the driver cockpit of the towed vehicle toward the brake pedal arm. An actuator controlled by a controller operatively connects to the first attachment. Actuation of the actuator by the controller causes the actuator to pull the first attachment toward the second attachment, thereby moving the brake pedal from the non-braking position to the braking position.

In one embodiment, there is provided an auxiliary braking system for use in a towed vehicle. The system may include an attachment, an actuator, a cable and a controller. The attachment may attach to a brake pedal arm of the towed vehicle. A cable attaches at a first end to the attachment and attaches at a second end to the actuator. The controller causes actuation by the actuator which in turn causes movement of the cable that causes the brake pedal of the towed vehicle to be depressed.

The actuator of the auxiliary braking device may be a pneumatic actuator and the controller may comprise an air compressor that provides pressurized air to the pneumatic actuator to cause movement of the cable.

In one embodiment, there is provided a method for installing an auxiliary braking device in a vehicle. The method may comprise connecting an attachment to a brake pedal arm of the vehicle, connecting a connection line to the attachment and connecting the connection line to an actuator. The connection line may be configured to pull the brake pedal arm toward a braking position of the brake pedal arm during a braking event.

In one embodiment, there is provided an auxiliary braking system for use in a towed vehicle comprising power assisted brakes that utilize a power brake booster. A brake pedal actuator actuates a brake pedal of the towed vehicle under the control of an air compressor. The air compressor may be operatively connected to selectively apply a vacuum to the power brake booster.

In one embodiment, there is provided an auxiliary braking system for use in a towed vehicle comprising a brake pedal actuator that actuates a brake pedal of the towed vehicle and a controller that draws power from a power supply of the towed vehicle to control the brake pedal actuator. One or more electrical connectors connect the power supply of the towed vehicle to the controller. The controller comprises an electrical supply inlet that receives input power from the towing vehicle and applies a trickle charge to the electrical connectors in order to provide a re-charge current to the power supply.

In one embodiment, there is provided an auxiliary braking system for use in a towed vehicle. A brake pedal actuator of the auxiliary braking system actuates a brake pedal of the towed vehicle under the control of a controller. The controller comprises control circuitry that receives a brake signal from a towing vehicle and actuates the brake pedal actuator in response to the brake signal. The controller comprises further control circuitry that detects a pattern of the brake signal and prevents actuation of the brake pedal actuator in response to detection of the pattern.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 is substantially schematic view of a towing vehicle/towed vehicle system;

FIG. 2 substantially depicts the components of an auxiliary braking system;

FIG. 2A substantially depicts an internal view of the controller;

FIG. 3 substantially depicts the connections for the auxiliary braking system;

FIGS. 4 and 5 substantially depict mounting configurations for the brake pedal clamp;

FIG. 6 substantially depicts an L-shaped clamp;

FIGS. 7 and 8 substantially depicts the operation of the brake pedal clamp;

FIG. 9 substantially depicts connection of the vacuum line to a power brake booster of the towed vehicle;

FIG. 10 a wiring diagram for the towed vehicle;

FIG. 11 shows an embodiment of an installation of the auxiliary braking system; and

FIG. 12 shows an alternative mounting configuration for the auxiliary braking system.

### DESCRIPTION OF CERTAIN EMBODIMENTS OF THE PRESENT INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

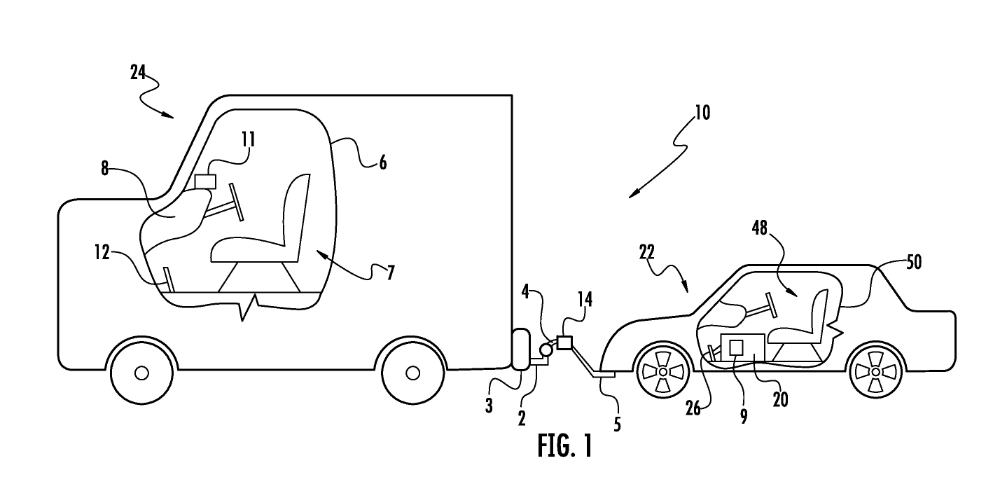

FIG. 1 is substantially a side view of a towing vehicle 24 and a towed vehicle 22 having an embodiment of the auxiliary brake system 10 of the present invention installed therein and used for stopping or slowing down the towed vehicle 22. Auxiliary brake system 10 may further comprise an auxiliary braking device 20 (hereinafter referred to as “ABD”) residing in the towed vehicle 22. ABD 20 supplements the brake system of a towing vehicle 24 in stopping or slowing down a vehicle being towed 22. In certain embodiments, ABD 20 provides auxiliary braking to towed vehicle 22 by operating the towed vehicle's brake pedal 26 and pulling on the brake pedal 26 during braking events.

Towing vehicle 24 is illustrated as having a towing “ball” 2 coupled to the frame 3 of towing vehicle 24. In other embodiments, a tow bar is received directly within a receptacle on the towing vehicle 24. A “hitch attachment” 4 is coupled to a suitable structure 5 of the towed vehicle 22. Accordingly, when hitch attachment 4 is coupled to towing ball 2, the towing vehicle 24 tows the towed vehicle 22. Of course, the above-described means of coupling the towing vehicle 24 and the towed vehicle 22 may be effected with any suitable means, and alternative embodiments of the auxiliary brake system 10 may be employed with any such means.

The cut-away line 6 demarks the outside and an inside portion 7 of the towing vehicle 24. For convenience, receiver unit 11 is illustrated as sitting on top of dashboard 8. In one embodiment, receiver unit 11 is affixed to dashboard 8 or some suitable location using a suitable means, such as Velcro, a strap, a bracket or the like. As will be discussed further, a receiver unit 11 may communicate with the ABD 20 to, among other things, provide an indication to occupants of the towing vehicle that the auxiliary brake system 10 is functioning as intended and/or is not functioning as intended and to provide an audible alarm for a breakaway or braking activities that should not be occurring.

The cut-away line 50 demarks the outside and an inside portion 48 of the towed vehicle 22. For convenience, an ABD 20 is illustrated as sitting on the floor of towed vehicle 22 in front of a driver seat. However, this position is arbitrary as will be readily understood from the description of the installation of ABD 20 below.

At least one embodiment includes a breakaway system 14. Break away system 14 is configured to detect separation of towed vehicle 22 from towing vehicle 24, such as during a failure of ball 2 and/or hitch attachment 4. This condition may be communicated to the driver of towing vehicle 24, such as by providing a visible or audible indicator on receiver unit 11. The condition may also be communicated to the ABD 20 to cause the brakes of the towed vehicle to be automatically applied. In one embodiment, the breakaway is always attached to the towed vehicle exclusively, and not to the towing system. In this way no matter what caused the breakaway, the system can recognize it. This prevents the break from occurring behind the breakaway device, which would not be detected.

The ABD 20 is intended for use with towed vehicles that have a standalone braking system that can be operated when the towed vehicle is independently driven by a driver situated in a driver cockpit of the vehicle. The braking system of the towed vehicle will typically include a brake pedal arm that moves from a passive, non-braking position to an active braking position in which the brakes of the vehicle are applied to slow the vehicle.

The ABD 20 is used when the towed vehicle is being towed. The ABD 20 is generally described as an auxiliary braking device because it is auxiliary to the towed vehicle's stand alone braking systems which would be used when the towed vehicle is being directly operated by a driver. In one common example, the towing vehicle may be a motorhome and the towed vehicle may be a regular car, four wheel drive, etc. It is common for such an arrangement because it facilitates long distance travel using the motorhome, while allowing a smaller vehicle to be driven for shorter journeys, such as within a city or town, visiting particular tourist destinations etc.

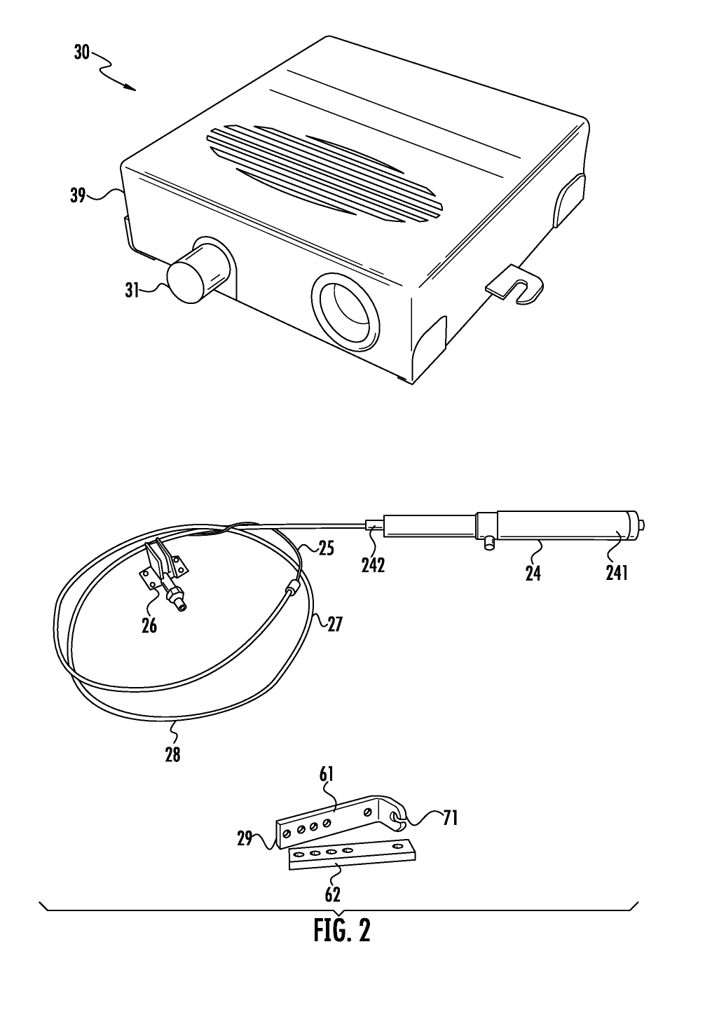

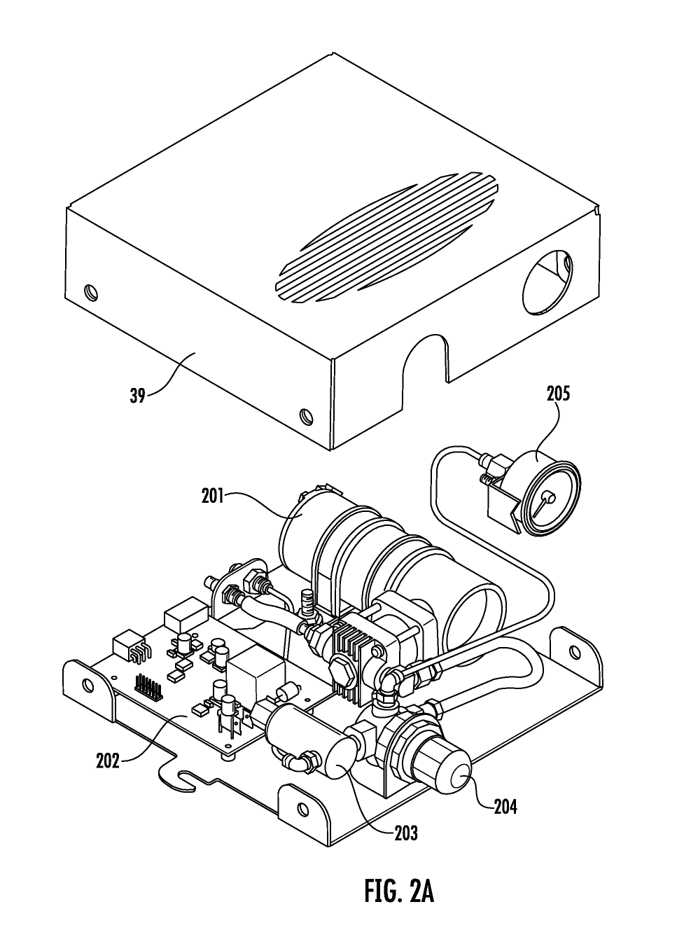

The components of the auxiliary braking system 20 are depicted in FIG. 2. The auxiliary braking system 20 includes a controller 30, an actuator 24, redirection device 26, connection line 28 and brake pedal attachment 29.

The actuator 24 is shown as a pneumatic actuator in the form of an air cylinder. Other types of actuators will be apparent to a person skilled in the art, including, without limitation, electromagnetic actuators, hydraulic actuators, motorized actuators and the like. The air cylinder 24 has an outer fixed element 241 intended to be secured to a body panel or similar element of the towed vehicle. The air cylinder also includes an inner moving element 242 that moves relative to the fixed element 241. The moving element 242 is connected to the connection line 28. The term connection line as used herein is intended to be construed broadly and will include various forms of connection lines including, without limitation, cables, plaited cable, wires, ropes, cords, chains, hydraulic lines, pneumatic lines, and all suitable equivalents thereof. In the embodiments described herein, the connection line is a cable 25 having a sheath 27 or cable housing for at least part of its length.

The redirection device 26 is shown herein as a pulley though other types of redirection devices will be apparent to the person skilled in the art including, without limitation, shackles, u-bolts, eyelets, ringlets, etc.

The controller 30 provides an integral unit having a housing 39. FIG. 2A shows an internal view of the controller 30. As described above, in one embodiment, the actuator is a pneumatic actuator. To control the actuator, the controller includes an air compressor 201 within the housing 39. The air compressor 201 provides pressurized air to air outlet 32 FIG. 3. Control circuitry 202 controls the flow of pressurized air to the outlet 32 by way of air valve 203. Control circuitry receives control signals from the towing vehicle through electrical connector 38. An adjustable regulator 204 allows control of the brake pressure as will be described in more detail below. A pressure gauge 205 provides a visual indicator of the brake pressure. While these components are provided within a single integrated controller, these components could also be provided in separate units.

FIG. 3 shows a rear-side view of the controller 30 showing the connections to the integrated control unit. The connections include a pressurized air outlet 32 that connects pressurized air from the outlet of the internal air compressor to the air cylinder 24 via an air line 33, a vacuum air outlet 34 that can supply vacuum air from the inlet side of the air compressor, a four wire harness connector 37 that connects to break-away system 14 and battery of the towed vehicle for powering the controller 30, and towing vehicle connection 38 which connects the controller to the wiring system of the towing vehicle. An embodiment of the wiring diagram is depicted in FIG. 10.

The controller 30 may be located at any suitable position within the towed vehicle. In some embodiments, an ideal location for the controller may be under the driver's or passenger's seat. Other locations within the interior of the vehicle include under the rear seats, in the trunk or behind panels. The controller can be mounted horizontally, vertically, upside down or in any orientation.

There are several factors that can be considered when selecting a location for the controller 30. The brake pressure adjustment knob 31 should be accessible to the installer. If mounted under the seats, the controller should not interfere with the movement of the seat or affect any adjustments to the seat. An electrical harness will be routed from the controller to the vehicle's battery (or if the battery is inaccessible, to an appropriate power source which will be energized when towing). The mounting location should be within reach by the wiring harness, which, in one embodiment, is 15 feet.

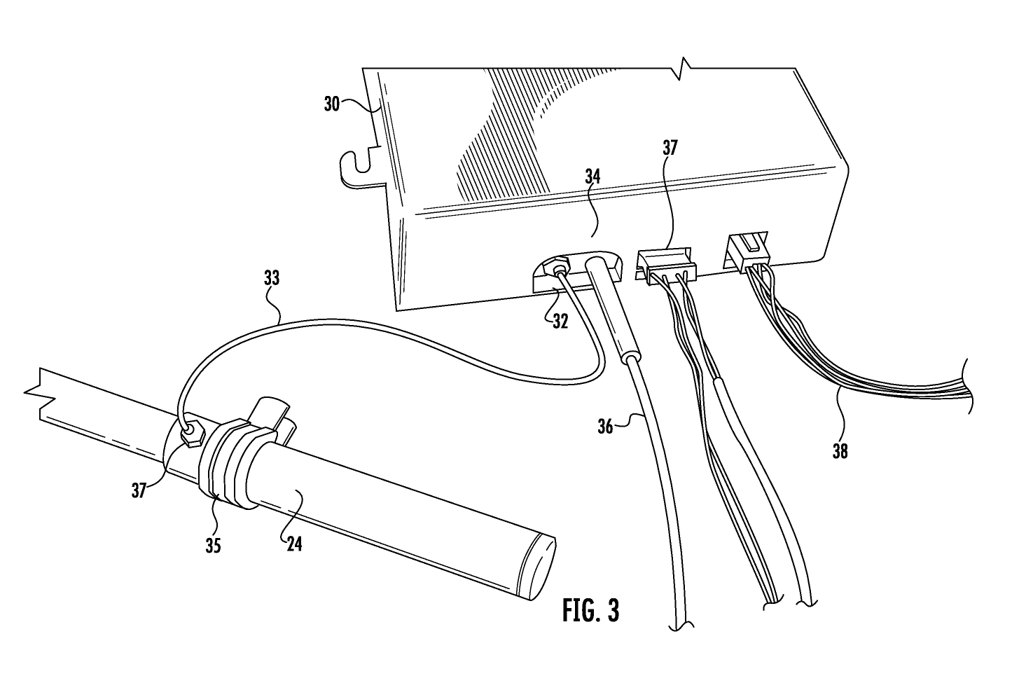

FIGS. 4 to 8 illustrate the connections of the ABD 20 to the brake system of the towed vehicle.

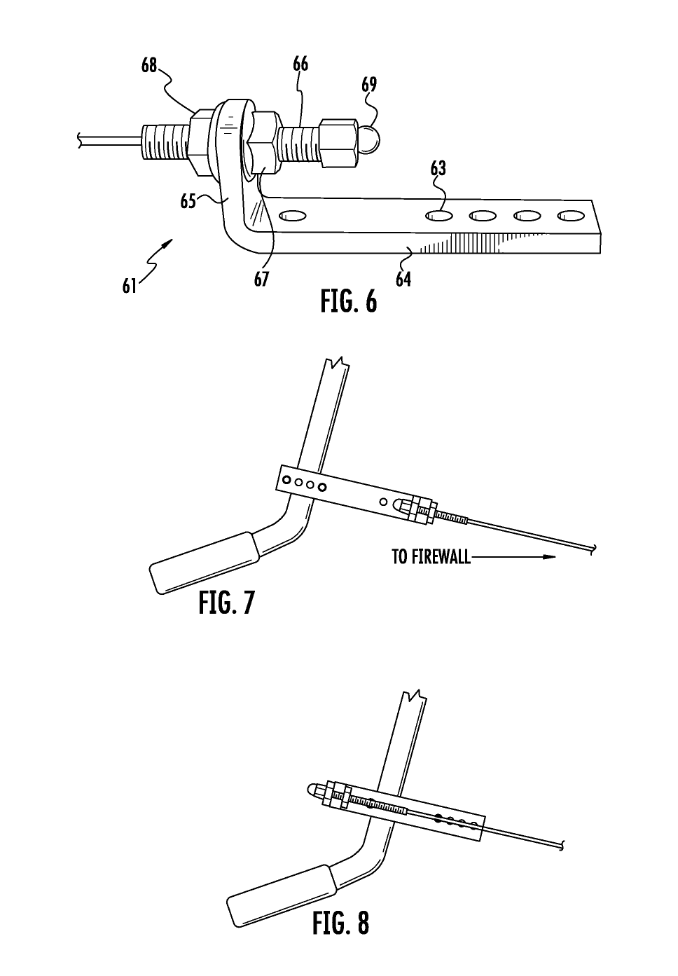

The brake pedal attachment 29 includes an L-shaped clamp 61 and a flat pedal clamp 62, as shown in FIG. 2. The L-shaped clamp is shown in more detail in FIG. 6. The L-shaped brake pedal clamp 61 includes a plurality of pre-drilled holes 63 in the long section 64 of the L-shaped clamp 61. The short section 65 of the L-shaped clamp 61 also includes a slot 71 (FIG. 2) that receives a threaded adjuster sleeve 66. The threaded adjuster sleeve has an internal aperture through which the cable 28 is received. The cable 28 terminates in a ball 69 that stops the cable 28 from passing completely through the adjuster sleeve 66. The adjuster sleeve 66 is retained in the short section 65 of the L-shaped clamp by an locking nut 67 and retaining nut 68.

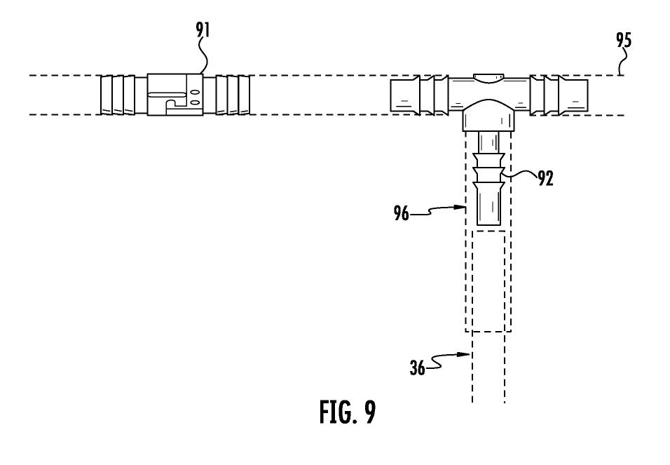

The two sections of the brake pedal clamp can be attached in the following ways:
With the slot 71 in the L-shaped clamp 61 on either side of the brake pedal arm 45 (FIG. 7).
With the slot rotated toward the firewall (FIG. 7) or away from it (FIG. 8).
The clamp may be attached with bolts through two of the five pre-drilled holes (FIG. 8). The clamp can be moved forward or backward on the brake pedal arm by using different attachment holes.
If more clearance is necessary, a portion of the clamp can be trimmed, once a decision has been made as to which two of the pre-drilled holes will be used to attach the clamp.

The clamp should be positioned as far down the brake pedal arm as possible. The farther down the clamp is mounted, the more efficiently the supplemental braking system will operate. Furthermore, if the brake pedal clamp is mounted too high there will not be enough travel for the controller 30 to apply the brakes properly. The pulley 26 and both sections of the brake pedal attachment 29 are positioned so that they are directly in line with each other.

The adjuster sleeve 66 (FIG. 6) may be attached to the slot 71 in the L-shaped clamp 61. With this in mind, a determination can be made as to which side of the brake pedal arm 45 will position the ball 69 at the end of the cable 28 directly in line with the pulley 26. Based on where the cable 28 will be anchored, the clamp can be rotated with the slot 71 toward the firewall or away from it. Once positioned, the installation should be checked to make certain that no part of the bracket interferes with the full and complete movement of the brake pedal arm.

If the towed vehicle is equipped with brake pedal presets, the cable and brake pedal clamp assembly can be installed with the brake pedal as close to the driver's seat as possible. As an option, the brake pedal may be moved to the desired position and disabled.

The pulley 26 can be mounted on the firewall or similarly suitable area within the driver cockpit. The purpose of the pulley 26 is to redirect the line of pull of the connection line as the actuator moves. In one embodiment, the pulley is mounted at a position behind the brake pedal arm as viewed from the driver cockpit of the towed vehicle toward the brake pedal arm. In this position, the brake pedal arm will be pulled in the same direction in which the brake pedal is configured to move, i.e. toward the pulley. In one embodiment, a suitable location for mounting the pulley is on the firewall in a location in which the pulley 26 is directly in line with the L-shaped brake pedal clamp 61 so that the cable 28 aligns directly to the center of the pulley wheel. Depending on which side of the brake pedal arm the L-shaped clamp 61 is attached, it may be necessary to adjust the position of the pulley slightly to the left or right.

Once the position of the components has been determined, the two sections of the brake pedal clamp 61, 62 can be positioned opposite each other. Using the two attachment points (FIGS. 7, 8) closest to the brake pedal arm, the clamp may be secured around the brake pedal arm using bolts to attach the pedal clamp components 61, 62. The adjuster sleeve 66 can then be attached to the brake pedal clamp 61 by completely unthreading the retaining nut 68 and inserting the adjuster sleeve 66 through the hole 71 in the L-shaped bracket 61.

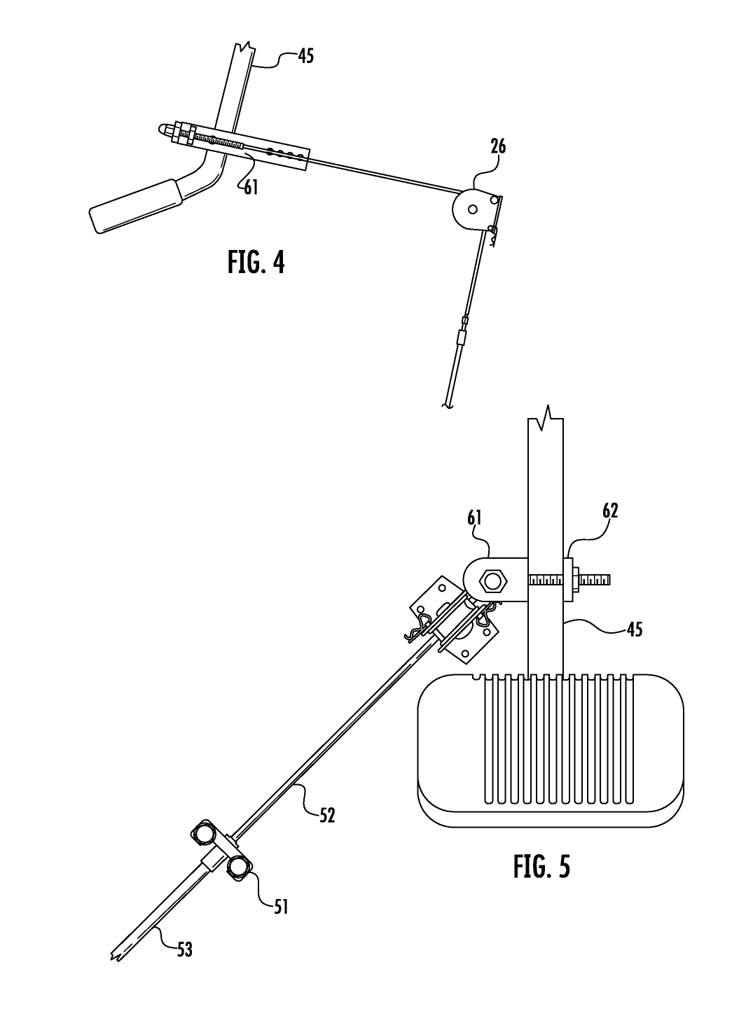

To attach the pulley, the bare portion 52 (FIG. 5) of the cable 28 is routed over the pulley 26 and the pulley 26 is positioned at the chosen mounting location, making certain that the cable is in a straight line from the brake pedal clamp to the pulley. If it is not, the following adjustments can be made:
. . . rotate the pulley, and/or
. . . move the pulley to a different location, and/or
. . . unfasten the brake pedal clamp and move it up or down the brake pedal arm, and/or
. . . attach the brake pedal clamp in a different way.

The pulley can then be mounted to the firewall or similar mounting plate using any suitable fastening means, such as self tapping screws, rivets, bolts, etc. Similarly, the cable anchor mounting bracket 51 (FIG. 5) may be mounted at the chosen location using suitable fastenings, such as self tapping screws etc. The cable anchor bracket 51 can be moved forward or backward until the ball 69 at the end of the cable is clearly visible. This will allow some free play in the cable, e.g. ¼″. The free play can be necessary to ensure that the towed vehicle's brakes will not be applied unless the supplemental braking system is activated. To adjust free play, the retaining nut 68 and locking nut 67 can be moved forward or backward on the adjuster sleeve 66.

Next, the cable 25 can be routed through the pulley and any other redirection devices, such as eyelets or clamps on the firewall or floor pan and attached to the air cylinder 24 using a suitable fastening, such as a band clamp 35 and self-tapping screw. If necessary, a sliding clamp can be used to secure the cable housing 27 in place. An air line 33, such as a ⅛″ air line can be used to connect the pressurized outlet 32 of the controller 30 to the air cylinder 24 by pressing one end of the line 33 into the port 37 on the air cylinder 24 until it bottoms out. The air line can be routed to the controller and, if necessary, trimmed to length. The air line 33 can be connected to the controller by pressing the appropriate end of the line 33 into the port 32 on the controller 30 (FIG. 3).

The vacuum line 36 shown in FIG. 3 is used on vehicles with vacuum-assisted power brakes. If the vehicle has a full-time (“active”) power braking system it will not have a power brake booster. Accordingly, there is no need to install the vacuum line and associated components. However, if required, a vacuum line 36, e.g. made of nylon, can be attached to the vacuum port 34 via a short piece of rubber vacuum hose. The vacuum port connects to the inlet side of the air compressor within the controller 30 and thus provides a vacuum side of the air compressor. The vacuum line 36 can be routed from the controller to the firewall, preferably choosing a route that will conceal the vacuum line. A pre-existing hole in the firewall should be used where possible, otherwise, a hole may be drilled through the firewall to route the nylon vacuum line through it and into the engine compartment of the towed vehicle and to the power brake booster.

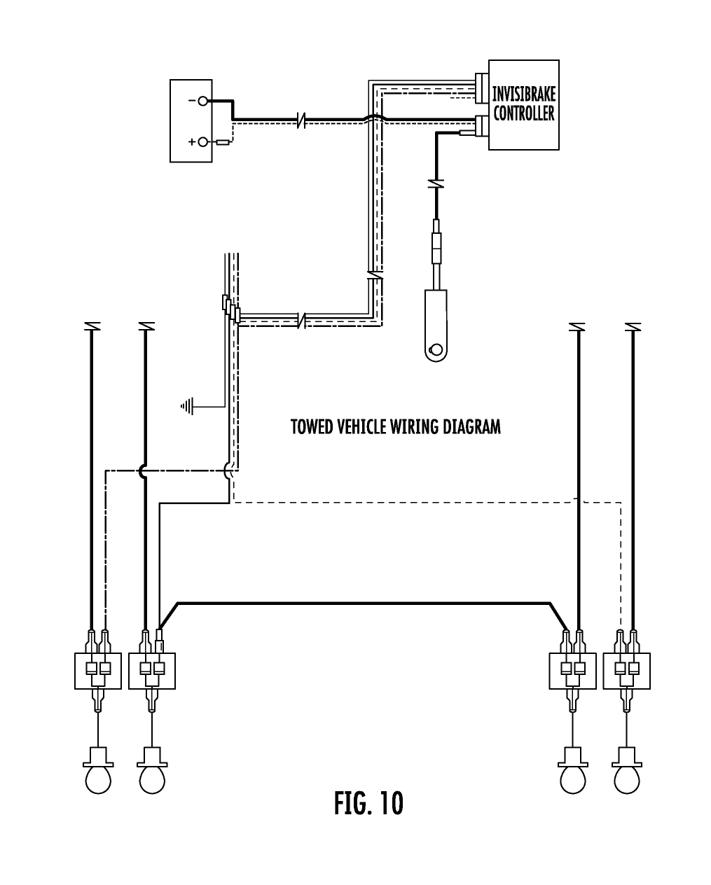

To connect the vacuum line, the vacuum line 95 coming out of the power brake booster is located and cut in two places. A check valve 91 and tee 92 is then inserted as shown in FIG. 9. The check valve 91 is inserted between the engine and the tee. The check valve 91 is positioned so that the barbed fitting with the band is closest to the engine, and so that the arrow on the check valve is pointing toward the engine. A vacuum hose 96 is pressed over the bottom of the tee 92 and then connected to the routed vacuum line 36, trimming the line 36 as necessary.

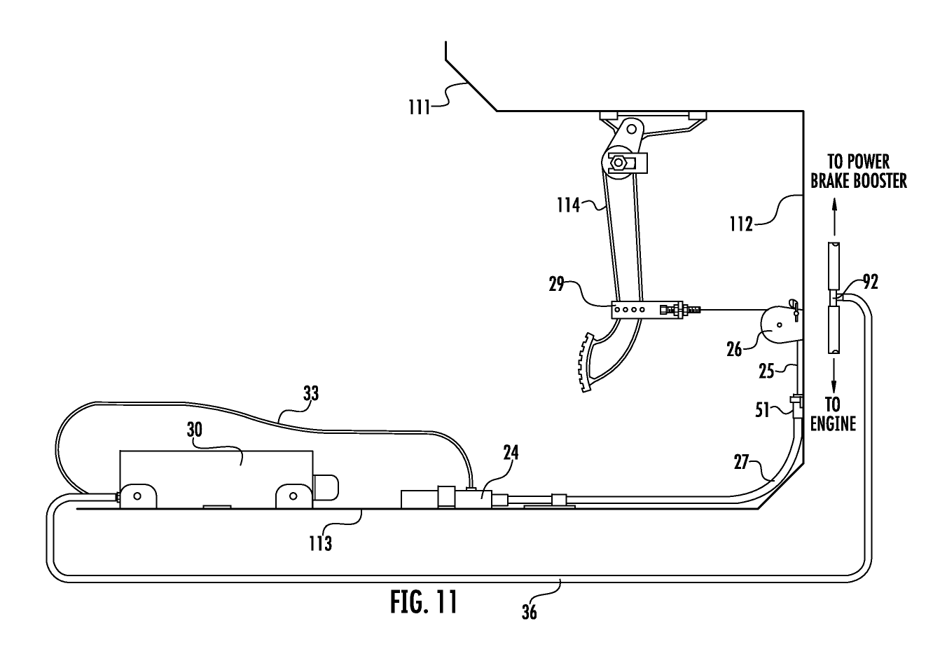

FIG. 11 depicts an embodiment of a completed installation of the ABD system within a towed vehicle. The driver compartment of the vehicle is shown including a dashboard 111, firewall 112, floor pan 113 and brake pedal 114. The controller 30 and air cylinder 24 are affixed on the floor pan 113 and the pulley 26 is secured to the firewall 112. The airline 33 is shown connected between the controller 30 and the air cylinder 24. The cable housing 27 extends from the air cylinder 24 to the cable anchor bracket 51 with the cable 25 running through the cable housing 27, around the pulley 26 and to the brake pedal clamp assembly 29 on the brake pedal 114. If required, the vacuum line 36 is routed underneath the floor 113 of the vehicle (or alternatively, through the firewall 112) to the tee fitting 92 located behind the firewall 112 in the engine bay of the towed vehicle.

Operation of the ABD system will now be described. When all components are correctly connected and the brakes of the towing vehicle are applied, the controller 30 detects the application of the towing vehicle brakes through the wiring connection 38. The control circuitry 202 receives a braking signal from the towing vehicle, e.g. from the brake light signal of the wiring harness 38, and operates the air compressor 201 in response thereto. The air compressor causes pressurized air to be applied to the air cylinder 24. Movement of the moving element 242 of the air cylinder 24 retracts the cable 28. Due to the location of the pulley being behind the pedal as viewed from the driver cockpit, the retraction of the cable causes the brake pedal to move toward the pulley, i.e. in the direction that causes the brakes to be applied. At the conclusion of the braking event, the brake signal from the towing vehicle ceases and the control circuitry correspondingly controls the air compressor 201 to cease operating. The control circuitry also controls the air valve 203 to cause the pressure in the air line 33 to be released, thereby allowing the spring action of the brake pedal arm to return the brake pedal arm to its passive or non-braking position.

As shown in FIGS. 2 and 2A, the controller includes a regulator 204. The regulator controls the downstream pressure that is applied to the actuator 24 and therefore controls the degree of movement of the actuator and hence the degree of movement of the brake pedal arm. The downstream pressure can be controlled using the brake adjustment knob 31.

Auxiliary braking systems are typically designed to either to work in conjunction with the towed car's power brake system or they are designed to work on a dead brake pedal. This limits the number of vehicles that one type of system may fit (particularly in light of new hybrid and electric vehicles). The adjustable pressure regulator allows the same system to be used on either type of vehicle. In addition, the pressure gauge 205 displays to the installer/driver to view the air pressure applied to the air cylinder 24, thereby allowing the installer/driver to make precise incremental brake force changes.

The ABD system described herein provides a number of advantages.

The air compressor and circuitry are enclosed within the controller housing 30 and the air cylinder 24 also includes a housing that encloses the end of the air cylinder so that movement of the air cylinder is within the housing, meaning that there are no moving parts to interfere or interact with any vehicle components or passengers.

The bracketry used to secure the cable assembly to the brake pedal arm has been designed so that:
a. It has multiple mounting holes to accommodate a wide range of brake pedal arms
b. The bracketry can be mounted forward or backward to facilitate ease of installation and clearance of the driver's foot and firewall.
c. The bracketry can be mounted on the left or right side of brake pedal arm to facilitate ease of installation and clearance of the driver's foot and firewall.

The system is designed to accommodate two distinctly different types of automotive braking systems. The two primary types are:

1. Traditional power brake boosters that utilize vacuum. These systems are not energized unless the car is running The controller works on these with the controller providing the vacuum necessary to power the towed vehicles brakes.

2. Full time active braking systems that have power brakes all the time regardless of whether the towed vehicle is running Normally a supplemental braking system would not work on this type of vehicle as it would over brake and lock up the brakes every time. The present system works on these vehicles by way of the adjustable regulator 31 on the controller 30 that allows the amount of brake force applied to the towed vehicle to be accurately tuned.

A particular advantage of the ABD system 20 is that there is nothing for the operator to do when connecting or disconnecting the towed vehicle from the towing vehicle. Most portable braking systems require the operator to put the braking system into the vehicle when the vehicle requires towing but to remove the ABD unit, or at least the brake pedal actuator, when the vehicle is to be directly driven. This is because in prior art systems, the braking system actuator sits in front of the brake pedal. The present system is a permanently installed braking system that becomes passive when the vehicle is directly driven. Furthermore, the controller circuitry does not need to be switched on when the ABD is to be used. Instead, the controller 30 becomes active when the electrical connection from the towing vehicle is made, e.g. by the electrical cord between the towing vehicle and the towed vehicle, and then the brakes come on in the towing vehicle. The electrical cord is something the operator must connect in order to make his brake lights and turn signals function on the back of the towed car and so will be connected whenever the towed vehicle is to be towed, thus ensuring that the ABD will be activated without any direct input from the operator. In essence, the operator connects the towed vehicle up to the towing vehicle like he always does and this allows the controller to work without having to remember to turn the system on or off.

One problem with many supplemental braking systems is that they work off of the towed car's battery. When the battery goes dead a) supplemental brakes no longer work b) emergency breakaway system no longer works c) there is a risk of accidents from the unexpected increased stopping distance. The controller circuitry therefore incorporates a trickle charge circuit that trickle charges the towed vehicle's battery as long as the towing vehicle park lights/tail lights are on. By incorporating a trickle charge line into the controller circuitry, it can be ensured that the ABD system will never drain the battery of the towed vehicle. The trickle charge circuit takes power from the taillight line of the towing vehicle through the wiring harness 38 and applies a trickle charge current to the towed vehicle battery (or other controller power supply) through the battery wires of the four wire harness 37.

The circuitry of the controller 30 is configured to monitor the brakes of the towed vehicle and not just activation of the ABD 20. If the ABD is incorrectly installed, the ABD may be indicated as activated but not actually depressing the brakes in the towed vehicle. Worse, if the installer does not install the braking system properly, it can actually depress the car's brake pedal even when the ABD is off. Another problem can occur where the driver of the towing vehicle rides with their foot on the brake. These latter scenarios can cause significant damage or even a brake fire in the towed vehicle. Without monitoring the actual state of the brakes, the driver in the towing vehicle may be unaware that the brakes are on in the towed vehicle until damage occurs. Regardless of what the ABD system is doing or not doing, the important parameter is whether the towed vehicle's brakes are on or off and that is the signal that is sent to the towing vehicle. A state of the towed vehicle's brakes may be monitored by connecting a monitor wire downstream of the brake light switch.

Logic within the controller circuitry monitors the period for which the brakes of the towed vehicle are applied. Testing by the present applicants has revealed that at normal freeway speeds, a complete braking event, i.e. from speed to completely stopped, can be completed within a specific period, for example 10 to 20 seconds or more particularly 15 seconds. Thus, the brakes of the towed vehicle being applied for longer than this period can be indicative of a failure of the brakes to release. A timer within the control circuitry records the time of a braking event and causes the ABD to release the brakes, e.g. by removing pressure to the air cylinder 24. Each time the operator of the towing vehicle takes their foot off the brakes this timer resets so this feature is invisible to the operator unless he continues to brake for more than 15 seconds and then the next time he steps on the brakes it starts all over again.

In addition to the automatic brake release, the controller is programmed to provide an audible alarm, via the monitoring circuits, to the towing vehicle whenever the brakes are detected as being continuously operated for greater than the auto-release period. In one embodiment, the alarm goes off if the controller detects continuous operation of the towed vehicle's brakes for more than 20 seconds. This audible alarm indicates that something is drastically wrong because the car's brakes are being applied but they are not supposed to be on. This solution can help make sure that any improper installations or faulty components don't cause severe braking damage as the operator is warned long before the brakes are on long enough to damage the car.

As described above, the controller 30 activates the brakes of the towed vehicle whenever a brake signal is received from the towing vehicle. But imagine that the operator is towing over a mountain pass at night and there is severe fog. So he turns on his emergency flashers. Most motorhomes flash the brake lights as they have combined brake and turn signals (i.e. they do not have separate amber turn signals). In this case, the ABD would see the brake lights of the towing vehicle going on and off and thus starts pulsating the brakes in the towed car in sync with the flashers. The logic of the controller 30 is programmed to identify a consistent pattern of brakes and after a few flashes it's smart logic detects that this is not braking but emergency flashers instead and the controller overrides the brake signal so that the towed vehicle no longer brakes in sync with the flashes. However the logic also dictates that the first flash that is of a different time parameter immediately engages the brakes again.

The controller 30 makes a dual use of the air compressor within the controller. In one aspect, the pressurized outlet of the air compressor provides pressurized air to the cylinder 24 to cause retraction of the cable to the brake pedal arm. In addition, the inlet to the air compressor, which by its very nature creates vacuum, is connected as a vacuum line to the Power Brake Booster vacuum line under the hood of the towed vehicle. This energizes the vacuum power brakes of the car so that for towing purposes the towed car has power brakes just like normal.

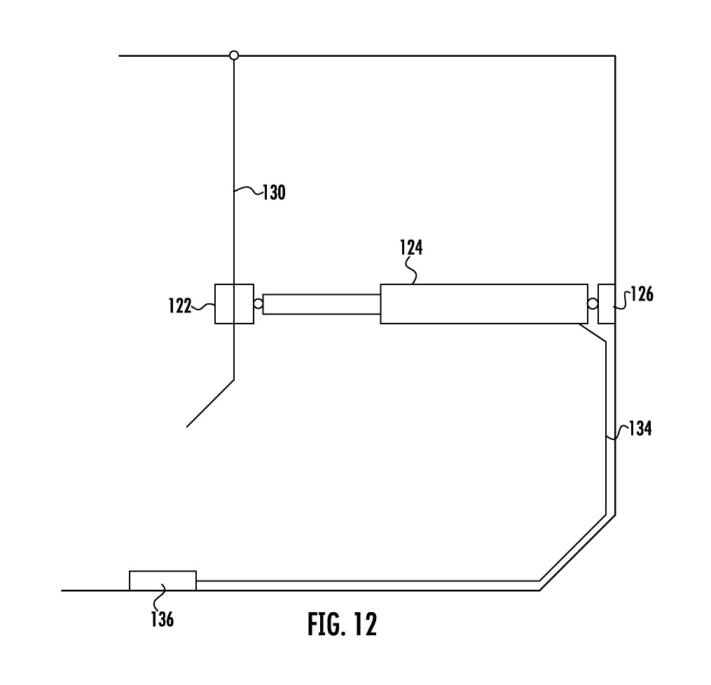

In the embodiments described above, the connection line provides the connection between the first attachment at the brake pedal arm and the second attachment behind the brake arm, i.e. at the pulley with the pulley then providing a redirection of the connection line to the actuator. It is in part because the actuator pulls on the brake pedal arm from behind the brake pedal arm that the presently described system provides significant advantage over prior art systems that require the brake pedal arm to be pushed from in front of the brake pedal. FIG. 12 shows an alternative embodiment for providing this pulling force on the brake pedal arm. In the embodiment of FIG. 12, the actuator 124 is used in the connection between the first attachment 122 at the brake pedal arm 130 and the second attachment 126 at the firewall behind the brake pedal arm. The air line 134 connects from the controller 136 to the actuator 124 in a similar manner to the embodiments described above but with added length to accommodate the position of the actuator 124. In operation, air pressure applied from the controller 136 to the actuator 124 causes the actuator 124 to contract, directly pulling on the brake pedal arm 130 and causing the brakes of the vehicle to be applied. The attachments 122, 126 may incorporate various pivots that allow that actuator to swing as the brake pedal arm 130 moves through its range of travel. Alternatively or in addition, the connection between the attachments 122, 126 may incorporate a cable from the actuator 124 as described previously.

The brake pedal has a range of motion and therefore may occupy an almost infinite number of positions within this range. The brake pedal arm may have an initial range of movement in which the brakes are not applied at all. After initial engagement of the brakes, any increased actuation of the brake pedal arm will cause higher braking forces. With regard to the description of the position of the brake pedal arm in the claims that follow, the term “a braking position” is used to define an antecedent for any position in which the brakes of the towed vehicle are applied and is not used to denote that only a single braking position of the brake pedal arm exists. The term “the braking position” with regard to the brake pedal arm is used to refer to an antecedent and is not used to denote that only a single braking position exists. Similar terminology applies for a/the non-braking position of the brake pedal arm. Functionally, unless the context indicates otherwise, it is necessary only to consider whether the brakes of the towed vehicle are applied or not and it is not necessary to consider the degree to which the brakes are applied or not.

Although the description above contains many specifications, these should not be construed as limiting the scope of the invention but as merely providing illustrations of some of the embodiments of this invention. Thus, the scope of the invention should be determined by the appended claims and their legal equivalents rather than by the examples given.

What is claimed is:

1. An auxiliary braking device for use in a towed vehicle, the towed vehicle including brakes, a driver cockpit, a brake pedal arm in the driver cockpit for applying the brakes, the brake pedal arm having a non-braking position in which the brakes of the towed vehicle are not applied and a braking position in which the brakes of the towing vehicle are applied, the auxiliary braking device comprising:
(A) an actuator comprising a fixed element and a moving element, the moving element configured to move relative to the fixed element;
(B) a controller that causes actuation by the actuator;
(C) a first attachment that attaches at a brake pedal arm of the towed vehicle;
(D) a second attachment that attaches to the towed vehicle at a position behind the brake pedal arm as viewed from the driver cockpit of the towed vehicle toward the brake pedal arm;
(E) a connection between the first attachment and the second attachment;
(F) wherein the moving element operatively connects to the first attachment; and
(G) wherein actuation of the actuator by the controller causes the moving element of the actuator to pull the first attachment toward the second attachment, thereby moving the brake pedal from the non-braking position to the braking position.

2. The auxiliary braking device of claim 1 wherein the connection comprises a connection line, wherein the moving element operatively connects to the first attachment via the connection line.

3. The auxiliary braking device of claim 2 wherein the first attachment comprises an adjuster for adjusting at least one of the length or the tension of the connection line.

4. The auxiliary braking device of claim 2:
(A) wherein the fixed element attaches to the towed vehicle at a position away from the second attachment;
(B) wherein the second attachment comprises a redirection device; and
(C) wherein the connection line connects from the moving element to the first attachment via the redirection device.

5. The auxiliary braking device of claim 4 wherein the redirection device comprises a pulley.

6. The auxiliary braking device of claim 4 wherein the connection line is a cable.

7. The auxiliary braking device of claim 1 wherein the actuator is a pneumatic actuator, the controller comprising:
(A) an air compressor;
(B) an air line that provides air pressure from the air compressor to the actuator.

8. The auxiliary braking device of claim 7 wherein the controller comprises control circuitry configured to:
(A) receive a braking signal from the towing vehicle; and
(B) in response to the braking signal, operate the air compressor to provide pressurized air to the actuator.

9. The auxiliary braking device of claim 7 wherein the controller comprises an adjustable regulator that allows a user to vary the pressure provided to the actuator by the air compressor.

10. The auxiliary braking device of claim 7 for use in a towed vehicle having vacuum-assisted power brakes, the auxiliary braking device comprising a vacuum line that provides vacuum pressure from the air compressor to a pressure booster of the brakes of the towed vehicle.

11. The auxiliary braking device of claim 7 wherein the air compressor is powered by the battery of the towed vehicle.

12. The auxiliary braking device of claim 1 wherein the actuator is disposed between the first attachment and the second attachment.

13. The auxiliary braking device of claim 12 wherein the moving element attaches at the first attachment.

14. The auxiliary braking device of claim 12:
(A) wherein the actuator comprises a fixed element that attaches at the second attachment; and
(B) wherein the moving element moves relative to the fixed element.

15. An auxiliary braking device for use in a towed vehicle comprising:
(A) an attachment for attaching to a brake pedal arm of the towed vehicle;
(B) an actuator;
(C) a connection line that attaches at a first end to the attachment and attaches at a second end to the actuator;
(D) a controller that causes actuation by the actuator; and
(E) wherein actuation by the actuator causes movement of the cable that causes the brake pedal of the towed vehicle to be depressed.

16. The auxiliary braking device of claim 15 wherein the actuator is a pneumatic actuator and wherein the controller comprises an air compressor that provides pressurized air to the pneumatic actuator to cause movement of the cable.

17. The auxiliary braking device of claim 16 comprising a vacuum line that provides vacuum pressure from the air compressor to a pressure booster of the brakes of the towed vehicle.

18. The auxiliary braking device of claim 15 comprising a redirection device located at a position behind the brake pedal arm as viewed from a driver cockpit of the towed vehicle toward the brake pedal arm, wherein the connection line extends from the actuator to the attachment via the redirection device.

19. The auxiliary braking device of claim 15 comprising an adjuster for adjusting at least one of the length or the tension of the connection line.

20. The auxiliary braking device of claim 15 an adjustable regulator that allows a user to vary the pressure provided to the actuator by the air compressor.

21. A method for installing an auxiliary braking device in a vehicle, the method comprising the steps, not necessarily in the order shown:
(A) connecting an attachment to a brake pedal arm of the vehicle;
(B) connecting a connection line to the attachment, the connection line configured to pull the brake pedal arm toward a braking position of the brake pedal arm; and
(C) connecting the connection line to an actuator that causes the connection line to pull the brake pedal arm during a braking event.

22. The method of claim 21 comprising connecting a controller to the actuator that selectively actuates the actuator.

23. The method of claim 22 wherein the controller comprises an air compressor and wherein the step of connecting the controller to the actuator comprises connecting an air line between the air compressor and the actuator.

24. The method of claim 23 wherein the controller comprises an adjustable regulator associated with the air compressor, the method comprising adjusting the adjustable regulator associated with the compressor to control the amount that the brake pedal arm moves during a braking event.

25. The method of claim 23 comprising connecting a vacuum line from the air compressor to a power brake booster of the vehicle.

26. The method of claim 21 comprising:
(A) disposing a redirection device at a position behind the brake pedal arm as viewed from a driver cockpit of the vehicle toward the brake pedal arm; and
(B) connecting the connection line between the attachment and the actuator via the redirection device.

27. An auxiliary braking system for a towed vehicle comprising:
(A) connection means for pulling the brake pedal arm from a non-braking position to a braking position;
(B) actuator means for actuating the connection means; and
(C) controlling means for selectively controlling the actuator means.

28. The auxiliary braking system of claim 27 comprising redirection means disposed at a position behind the brake pedal arm as viewed from a driver cockpit of the vehicle toward the brake pedal arm, the redirection means for redirecting a connection of the connection means between the brake pedal arm and the actuator means.
(A)

29. An auxiliary braking device for use in a towed vehicle comprising power assisted brakes that utilize a power brake booster, the auxiliary braking device comprising:
(A) a brake pedal actuator that actuates a brake pedal of the towed vehicle; and
(B) an air compressor that provides pressurized air to the brake pedal actuator and that provides vacuum pressure to the power brake booster.

30. An auxiliary braking system for use in a towed vehicle comprising:
(A) a brake pedal actuator that actuates a brake pedal of the towed vehicle;
(B) a controller that draws power from a power supply of the towed vehicle to control the brake pedal actuator;
(C) one or more electrical connectors that connect the power supply of the towed vehicle to the controller; and
(D) wherein the controller comprises an electrical supply inlet that receives input power from the towing vehicle and applies a trickle charge to the electrical connectors in order to provide a re-charge current to the power supply.

31. The auxiliary braking system of claim 30 wherein the controller comprises an air compressor that is powered by the power supply of the towed vehicle, the air compressor providing pressurized air to the brake pedal actuator.

32. The auxiliary braking system of claim 30 wherein the electrical supply inlet receives power from a taillight line of the towing vehicle.

33. An auxiliary braking system for use in a towed vehicle comprising:
(A) a brake pedal actuator that actuates a brake pedal of the towed vehicle;
(B) a controller that controls actuation of the brake pedal actuator;
(C) wherein the controller comprises control circuitry that:
(a) receives a brake signal from a towing vehicle;
(b) actuates the brake pedal actuator in response to the brake signal;
(D) wherein the controller comprises further control circuitry that:
(a) detects a pattern of the brake signal; and
(b) prevents actuation of the brake pedal actuator in response to detection of the pattern.

34. The auxiliary braking device of claim 33 wherein the further control circuitry is configured to detect a flashing pattern of the brake signal and prevent actuation of the brake pedal actuator during the flashing pattern.

35. The auxiliary braking device of claim 34 wherein the further control circuitry is configured to detect a brake signal that is of a different time parameter to the flashing pattern during the flashing pattern and in response, cause actuation of the brake pedal actuator.
